(19) United States
(12) Patent Application Publication
(10) Pub. No.: US 2017/0109912 A1
(43) Pub. Date: Apr. 20, 2017

(54) CREATING A COMPOSITE IMAGE FROM MULTI-FRAME RAW IMAGE DATA

(71) Applicant: Motorola Mobility LLC, Chicago, IL (US)

(72) Inventors: Philip G. Lee, Chicago, IL (US); Gabriel B. Burca, Palatine, IL (US); Daniel T. Moore, Palatine, IL (US); James A. Rumpler, Chicago, IL (US)

(21) Appl. No.: 14/883,689

(22) Filed: Oct. 15, 2015

(51) Int. Cl. G06T 11/60; G06K 9/62; G06T 7/00; G06T 5/00; G06K 9/46

(52) U.S. Cl. CPC G06T 11/60; G06T 5/003; G06K 9/4604; G06T 7/0038; G06K 9/6202; G06T 2207/10016; G06T 2207/20221

(57) ABSTRACT

A method, a system, and computer program product for creating a composite image from multi-frame raw image data. The method includes extracting each individual frame from a plurality of frames within raw image data and determining a sharpness score for a region of each individual frame. A particular frame that has a sharpest region from among the plurality of frames is then selected as a reference frame. Each pixel in the reference frame is then registered to a plurality of corresponding pixels from non-reference frames of the plurality of frames. Equivalent pixels from the reference frame and each non-reference frame are then summed to create a composite image.

### BACKGROUND

1. Technical Field

The present disclosure generally relates to image processing systems and in particular to an improved method for creating an improved composite image from a multi-frame raw image data.

2. Description of the Related Art

When trying to capture images under non-ideal conditions such as indoors or in low light environments, exposure times often must be increased in order to capture properly the image. During capture of an image using an image sensor, any movement introduced, either by a subject in a field of capture or by the image sensor itself, will have a detrimental effect on the resulting image, most likely in the form of blurring in the captured image.

### BRIEF DESCRIPTION OF THE DRAWINGS

FIG. 1 provides a block diagram representation of an example system within which certain aspects of the disclosure can be practiced, in accordance with one or more embodiments;

FIG. 2 illustrates an example image processing component that creates a composite image from a multi-frame raw image data, in accordance with one or more embodiments;

FIG. 3 is a flow chart illustrating a method for creating a composite image from a multi-frame raw image data, in accordance with one or more embodiments;

FIG. 4 is a flow chart illustrating a method for creating a composite image from one or more identified patches in a multi-frame raw image data, based on an identified spatial relationship between a first pixel in a reference frame relative to remaining pixels in a patch of pixels in the reference frame, in accordance with one or more embodiments; and

FIG. 5 is a flow chart illustrating a method for creating a composite image from multi-frame raw image data captured by a remotely connected device, in accordance with one or more embodiments.

### DETAILED DESCRIPTION

The illustrative embodiments provide a method, a system, and computer program product for creating a composite image from multi-frame raw image data. The method includes extracting each individual frame from a plurality of frames within raw image data and determining a sharpness score for a region of each individual frame. A particular frame that has a sharpest region from among the plurality of frames is then selected as a reference frame. A correspondence is then determined between each pixel in the reference frame and a plurality of pixels from non-reference frames among the plurality of frames. Pixels in the non-reference frames are then registered with a corresponding pixel in the reference frame. Equivalent pixels from the reference frame and each non-reference frame are then summed to create a composite image.

In one embodiment, the method includes identifying a second pixel in at least one non-reference frame that corresponds to a first pixel in the reference frame. At least one patch of pixels in at least one non-reference frame that includes the second pixel is then associated with a patch of pixels in the reference frame that includes the first pixel. The association is based on a spatial relationship between the first pixel in the reference frame relative to the remaining pixels in the patch of pixels in the reference frame. A plurality of associated patches of pixels in non-reference frames for each patch of pixels in the reference frame are then summed to create the composite image

In another embodiment, each of the plurality of corresponding pixels in the non-reference frames is weighted based on pre-established desirability criteria (e.g., based on the sharpness score of the associated non-reference frame or proximity to a roll axis). Only equivalent pixels from the non-reference frames that meet a threshold associated with the pre-established desirability criteria are summed with pixels from the reference frame to create the composite image.

In yet another embodiment, the raw image data are captured using at least one image sensor, and motion data that describes a motion of the at least one image sensor is also captured for each frame of the plurality of frames, during capture of the raw image data. The motion data are then used to map a motion of each individual pixel between the reference frame and the non-reference frames. The motion data are further utilized in registering the plurality of corresponding pixels and identifying equivalent pixels between the reference frame and each non-reference frame.

In one embodiment, the raw image data are one of a video recording captured by one or more image sensors. In an alternate embodiment, the raw image data are a set of image frames captured by one or more image sensors.

In another embodiment, at least one post-processing image enhancement from among sharpness adjustment, white balance correction, exposure compensation, and noise reduction is applied to at least one of the reference frame, the non-reference frames, and the composite image. In an alternate embodiment, at least one post-processing image enhancement is performed to at least one of: (i) a pre-summing operation to identify optimal pixels to sum; (ii) a summing operation that sums only the original non-processed frames in the composite image; and (iii) a combination of the pre-summing operation and the summing operation.

In an alternate embodiment, the raw image data are received at a cloud-processing system from a remotely connected device that has at least one image sensor, which captured the raw image data. Motion data that describes a motion of at least one image sensor is then retrieved for each frame of the plurality of frames. Using the motion data, a motion of each individual pixel is then mapped between the reference frame and the non-reference frames. The mapping is used to register a plurality of corresponding pixels from non-reference frames among the plurality of frames to pixels in the reference frame. Equivalent pixels from the reference frame and each non-reference frame are then summed to create a composite image. In response to creating the composite image, the composite image can be transmitted to the remotely connected device and/or is saved to a cloud-based image library that is accessible by the remotely connected device.

In an alternate embodiment, a capture location of the raw image data are determined based on a location associated with the raw image data. In response to determining the capture location, one or more secondary frames recorded by at least one secondary image sensor are selected. The one or more secondary frames are ones that depict the capture location. Equivalent pixels between the reference frame, each non-reference frame, and the one or more secondary frames are then summed to create the composite image.

The above contains simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the following figures and the remaining detailed written description. The above as well as additional objectives, features, and advantages of the present disclosure will become apparent in the following description.

In the following detailed description of exemplary embodiments of the disclosure, specific exemplary embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various requirements are described, which may be requirements for some embodiments but not other embodiments.

The terminology used herein is for describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that term is utilized.

As utilized herein, raw image data refers to a multiple-frame image data. The raw image data may be, for example, but not limited to, a video recording (including high frame rate video such as 120 or 240 frame per second (FPS) video), a burst image, a set of images, or any suitable combination of the foregoing. The raw image data may be captured by a single image sensor or multiple image sensors working independently and/or in tandem.

Those of ordinary skill in the art will appreciate that the hardware components and basic configuration depicted in the following figures may vary. For example, the illustrative components within data processing system 100 are not intended to be exhaustive, but rather are representative to highlight essential components that are utilized to implement the present disclosure. For example, other devices/components may be used in addition to or in place of the hardware depicted. The depicted example is not meant to imply architectural or other limitations with respect to the presently described embodiments and/or the general disclosure.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural or functional or otherwise) on the described embodiments.

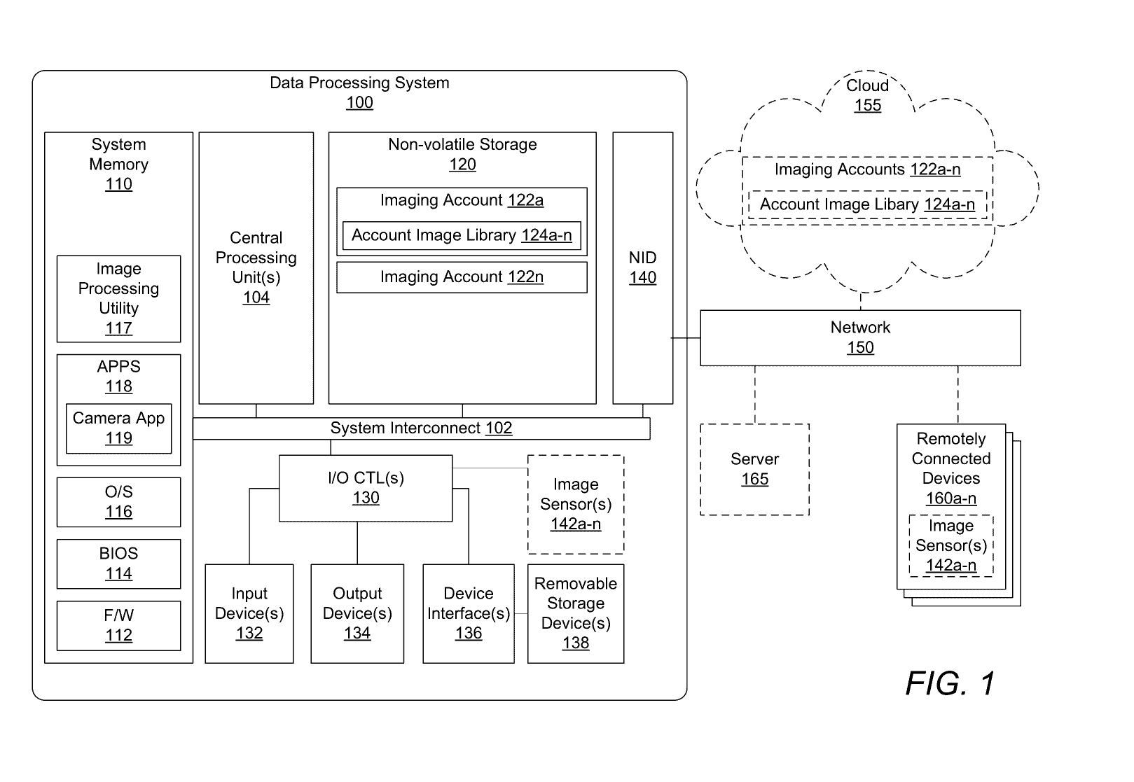

With reference now to the figures, and beginning with FIG. 1, there is depicted a block diagram representation of an example data processing system (DPS) 100, within which one or more of the described features of the various embodiments of the disclosure can be implemented. Data processing system 100 includes at least one central processing unit (CPU) or processor 104 coupled to system memory 110 via system interconnect 102. System interconnect 102 can be interchangeably referred to as a system bus, in one or more embodiments. These one or more software and/or firmware modules can be loaded into system memory 110 during operation of DPS 100. Specifically, in one embodiment, system memory 110 can include therein a plurality of such modules, including one or more of firmware (F/W) 112, basic input/output system (BIOS) 114, operating system (OS) 116, and application(s) 118. In one embodiment, applications 118 may include camera application 119. These software and/or firmware modules have varying functionality when their corresponding program code is executed by CPU 104 or secondary processing devices within data processing system 100.

Image processing utility (IPU) 117 is a utility that executes within DPS 100 to provide logic that performs the various method and functions described herein. For simplicity, IPU 117 is illustrated and described as a stand-alone or separate software/firmware/logic component, which provides the specific functions and methods described below. However, in at least one embodiment, IPU 117 may be a component of, combined with, or incorporated within OS 116 and/or one or more of applications 118, such as a camera application 119. In yet another embodiment IPU 117 may be a component that is accessed or retrieved by a remotely connected device 160.

In one embodiment, DPS 100 may be a server or cloud device that executes IPU 117 for performing the various method and functions described herein. In an alternate embodiment DPS 100 can be a personal device such as a desktop computer, notebook computer, mobile phone, tablet, or any other electronic device that supports image processing and/or image capture.

Data processing system 100 further includes one or more input/output (I/O) controllers 130, which support connection by and processing of signals from one or more connected input device(s) 132, such as a keyboard, mouse, hardware button(s), touch screen, infrared (IR) sensor, fingerprint scanner, or microphone. I/O controllers 130 also support connection to and forwarding of output signals to one or more connected output devices 134, such as monitors and audio speaker(s). Additionally, in one or more embodiments, one or more device interfaces 136, such as an optical reader, a universal serial bus (USB), a card reader, Personal Computer Memory Card International Association (PCMIA) slot, and/or a high-definition multimedia interface (HDMI), can be associated with DPS 100. Device interface(s) 136 can be utilized to enable data to be read from or stored to corresponding removable storage device(s) 138, such as a compact disk (CD), digital videodisk (DVD), flash drive, or flash memory card. In one or more embodiments, device interfaces 136 can further include General Purpose I/O interfaces such as I²C, SMBus, and peripheral component interconnect (PCI) buses.

I/O controllers 130 further support connection to image sensors 142a-n of DPS 100, which are used to capture raw image data in accordance with one embodiment of the invention. In another embodiment image sensors 142a-n may be located within one or more remotely connected devices 160a-n that interface with DPS 100 via network 150 and/or via a wired or wireless connection to system interconnect 102 and/or I/O controllers 130. Remotely connected devices 160a-n may be used to capture raw image data for processing by DPS 100 and/or server 165. Raw image data captured using image sensors 142a-n may be processed any one or more of IPU 117, remotely connected devices 160a-n, and/or server 165 in order to generate a composite image as described in greater detail below. In an alternate embodiment, any combination of DPS 100, remotely connected devices 160a-n, and server 165 may collectively process raw image data captured by image sensor(s) 142a-n in order to generate a composite image as described herein.

Also coupled to system interconnect bus 102 is nonvolatile storage 120, within which can be stored one or more software and/or firmware modules and one or more sets of data that can be utilized during operations of DPS 100. Imaging accounts 122a-n may also be stored within non-volatile storage 120. Each imaging account is associated with at least one party, for example, but not limited to, users, families, devices, clients, and/or any combination thereof. An imaging account 122 may further include at least one account image library 124 for storing raw image data, composite images, and/or other images, including secondary images, as described in further detail below. Each imaging account 122 is associated with one or more identifiers, for example, but not limited to, an electronic mail address, a location, a phone number, a unique identifier (UID), device identifier, handle/nickname, account name, and/or account number. While imaging accounts 122a-n are illustrated within nonvolatile storage 120, imaging accounts 122a-n and/or account image libraries 124a-n may also be stored in system memory 110, in cloud network 155, and/or in one or more external storage repositories (not pictured). Further, imaging accounts 122a-n and/or account image libraries 124a-n may be further accessible by DPS 100, cloud network 155, server 165, remotely connected devices 160a-n, and other devices (not pictured) connected thereto.

Data processing system 100 comprises a network interface device (NID) 140. NID 140 enables DPS 100 and/or components within DPS 100 to communicate and/or interface with other devices, services, and components that are located external to DPS 100. These devices, services, and components can interface with DPS 100 via an external network, such as example network 150, using one or more communication protocols. Network 150 can be a local area network, wide area network, personal area network, and the like, and the connection to and/or between network and DPS 100 can be wired or wireless or a combination thereof. For purposes of discussion, network 150 is indicated as a single collective component for simplicity. However, it is appreciated that network 150 can comprise one or more direct connections to other devices as well as a more complex set of interconnections as can exist within a wide area network, such as the Internet. DPS 100 may also directly connect to cloud network 155, server 165, and/or one or more remotely connected devices 160a-n via NID 140.

Additionally, network 150 may also be further connected to server 165 and/or one or more remotely connected devices 160a-n. In one embodiment cloud 155 and/or server 165 may also include IPU 117, camera application 119 and one or more imaging accounts 122a-n that are associated with one or more account image libraries 124a-n in order to perform one or more functions and methods described herein. Server 165 may facilitate the transmission, storage, and/or processing of raw image data captured by any image sensor(s) 142a-n, including image sensors of DPS 100, remotely connected devices 160a-n, and/or other devices (not pictured) that are connected to network 150 or cloud 155. DPS 100, cloud network 155, remotely connected devices 160a-n, and/or any other devices (not pictured) connected to server 165 may deposit, retrieve, access, modify, process, or post-process raw image data or composite images stored within server 165.

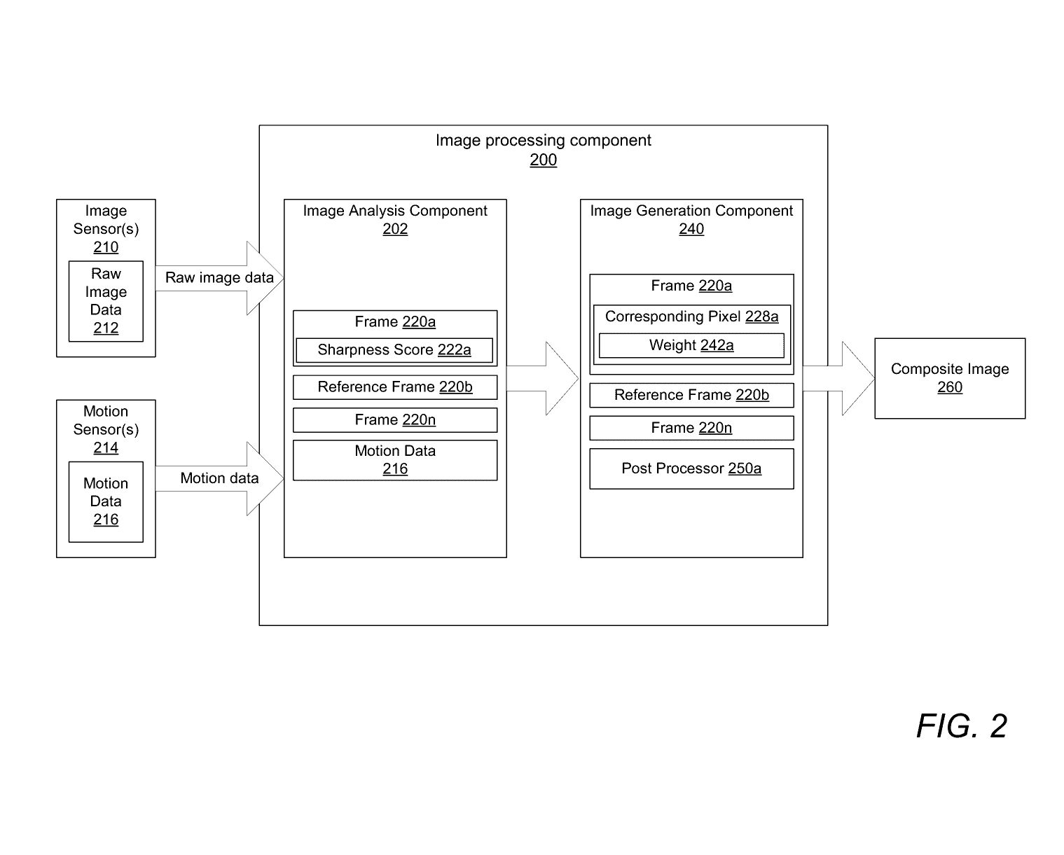

FIG. 2 illustrates an example image processing component (IPC) 200 that creates a composite image from a multi-frame raw image data, in accordance with one or more embodiments. IPC 200 includes a processor that executes IPU 117. In another embodiment IPC 200 may be a general purpose data processing system such as DPS 100 or server 165.

IPC 200 includes image analysis component 202 that receives raw image data 212 captured by image sensors 210a-n and image generation component 240 that registers and sums equivalent pixels between frames of the raw image data in order to create composite image 260. Image analysis component 202 may also receive motion data 216. In one embodiment, motion data 216 describes a motion of image sensors 210a-n for each frame of raw image data 212. Motion sensors 214a-n may be located within a same device as image processing component 200 and image sensors 210a-n. In another embodiment, image sensors 210a-n and/or image motion sensors 214a-n are located within a same device as image processing component 200. In another embodiment image sensors 210a-n and/or image motion sensors 214a-n are located in one or more other devices that are communicatively coupled to IPC 200 (e.g., remotely connected devices 160a-n and server 165). Image sensors 210a-n may include any image capturing component such as, but not limited to, a complementary metal-oxide semiconductor (CMOS) sensor. Motion sensors 214a-n may include any sensors used for detecting motion, including, but not limited to, gyroscopic sensors, accelerometers, and magnetometers.

In response to receiving raw image data 212, image analysis component 202 extracts and determines a sharpness score of each frame 220a-n of raw image data 212. In one embodiment, the sharpness score is based on a determined sharpness of each frame 220 as a whole. In another embodiment, the sharpness score for a particular frame is based on a sharpness associated with a particular region within the frame. The region of a frame that is used to determine the sharpness score may be include the entire frame, a subset of pixels of the frame, a user-selected area within the frame, an area within the frame that contains a particular object/subject (e.g., faces detected by image analysis component 202), etc. In response to determining a sharpness score associated with each frame 220 of raw image data 212, image analysis component 202 selects, as a reference frame (reference frame 220b), the sharpest frame from among the frames 220a-n.

In response to selecting reference frame 220b, image generation component 240 identifies and registers, to each particular pixel in the reference frame, pixels in non-reference frames that correspond to the particular pixel in the reference frame.

In one embodiment, image generation component 240 uses motion data 216 to map motion of a pixel between the reference frame and the non-reference frames. Once a particular pixel in reference frame 220b has been mapped to one or more non-reference frames, the corresponding pixels in non-reference frames may be registered to the particular pixel in the reference frame. In an alternate embodiment, image generation component 240 may perform a fast Fourier transform (FFT) analysis on each frame. Image generation component 240 may then detect similar or equivalent correlation peaks in the FFT analysis in order to identify pixels in non-reference frames that correspond to a particular pixel in a reference frame.

Image generation component 240 may also determine a weight 242a-n for each pixel 228a-n in the non-reference frames that corresponds to a particular pixel in a reference frame based on pre-established desirability criteria. In one embodiment, the weight of each pixel may be directly associated with a sharpness score of a corresponding individual frame containing the pixel. In an alternate embodiment, the weight assigned to a pixel may be further determined based on a particular location within a frame where the pixel is located and/or the proximity of a particular pixel to a roll axis associated with the raw image data.

For each pixel in reference frame 220b, image generation component 240 sums each corresponding registered pixel of the non-reference frames to create composite image 260. Composite image 260 may be saved locally or in a cloud-based image library and/or may be transmitted to another device (e.g., remotely connected device 160). In another embodiment, non-reference frames may be sequentially summed with a reference frame (and/or secondary frames) and a composite image may be saved and/or transmitted after each summing operation.

In one embodiment, one or more post processing image enhancements may be applied, via post processor 250, to composite image 260 prior to saving or transmitting composite image 260. The post processing effects include, but are not limited to, sharpness adjustment, white balance correction, exposure compensation, and noise reduction.

In an alternate embodiment, one or more post processing image enhancements may be applied, via post processor 250, to at least one of reference frame 220b, non-reference frames 220, and composite image 260. The post-processing image enhancements may be used by image generation component 240 to identify optimal pixels to sum together, while using a separate set of non-processed non-reference frames to create the composite image, In the event excessive motion is detected in the pixels between the reference frame and the non-reference frames, the composite image may also be cropped such that pixels around the edge of the composite image meet a particular sharpness threshold.

In another embodiment, image sensors 210a-n may also include a color-filter array that captures infrared (IR) data. Image sensors 210a-n may also include a polarization filter that is used to capture IR data for only a subset of frames of the raw image data (e.g., alternating IR filtered frames and IR unfiltered frames). Any captured IR data may be used by image generation component 240 to track pixels between frames. Additionally, image generation component 240 may also subtract IR data from the IR filtered frames in order to sum pixels in those frames in generation of the composite image.

In an alternate embodiment, only registered pixels that meet a threshold associated with the pre-established desirability criteria are summed with an associated pixel in the reference frame. The threshold may be based on, for example, a weight assigned to a pixel, a number of non-reference frames, a number of registered pixels for a particular pixel in the reference frame, and/or a sharpness score of the reference frame and/or one or more non-reference frames.

In still another embodiment, image analysis component 202 identifies a second pixel in one or more non-reference frames that corresponds to a first pixel in reference frame 220b. In response to identifying the second pixel, image analysis component 202 selects a patch of pixels in the reference frame that includes the first pixel and determines a spatial relationship between the patch of pixels and the first pixel (e.g., the first pixel being a northwestern most pixel in a 3×3 grid of pixels). Image analysis component 202 then associates a patch of pixels in one or more non-reference frames that correspond to the patch of pixels in the reference frame (e.g., a 3×3 grid of pixels in a non-reference frame that has the second pixel as the northwestern most pixel). Image generation component 240 then sums the patches of pixels in the non-reference frames that correspond to the patch of pixels in reference frame 220b in order to create composite image 260. The size of the patch of pixels is not limited to a specific dimension or shape.

In another embodiment, image analysis component 202 and/or image generating component 240 may also determine a capture location of the raw image data based on a location associated with the raw image data. The capture location may be determined based on location metadata associated with one or more frames in the raw image data or with the raw image data as a whole. Alternatively, image analysis component 202 and/or image generation component 240 may parse one or more frames in the raw image data in order to match a location depicted in the frames to a location depicted in one or more secondary frames. The secondary frames may include, but are not limited to, any of: one or more previously captured frames stored in a database that is communicatively coupled to IPC 200, one or more frames captured by other remotely connected devices, or one or more frames simultaneously captured by a second image sensor(s). The secondary frames may be a set of processed frames, one or more composite images, and/or another raw image data. In response to determining the capture location, image generation component 240 selects one or more secondary frames that also depict the capture location. Image generation component 240 then sums equivalent pixels between the reference frame, each non-reference frame, and the one or more secondary frames. Thus, the created composite image 260 incorporates one or more pixels from the one or more secondary frames. In one embodiment, the secondary frames may be used to enhance adverse conditions present in the raw image data, such as low or poor lighting conditions.

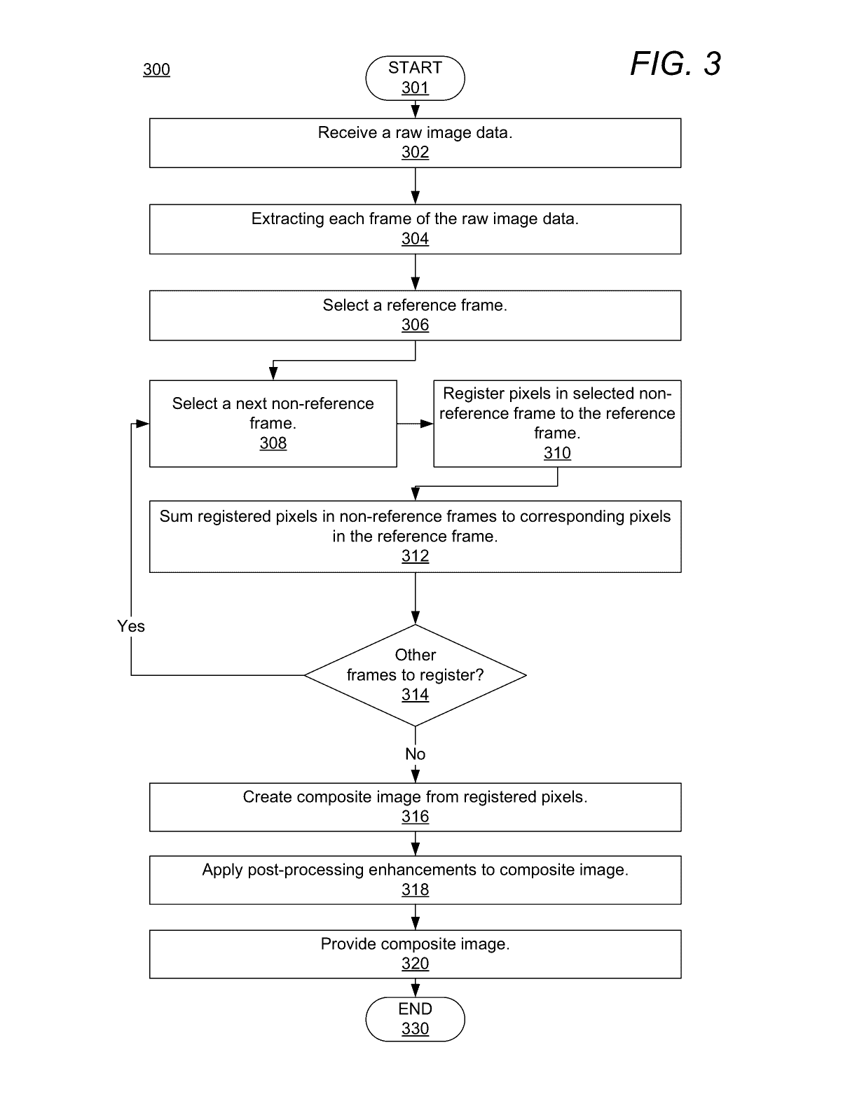

Referring now to FIGS. 3-5, there are illustrated flow charts of various methods for creating a composite image from a multi-frame raw image data, according to one or more embodiments. Aspects of the methods are described with reference to the components of FIGS. 1-2. Several of the processes of the methods provided in FIGS. 3-5 can be implemented by the CPU 104 executing software code of IPU 117 within a data processing system. For simplicity, the methods described below are generally described as being performed by DPS 100.

Referring now to FIG. 3, there is depicted a high-level flow-chart illustrating a method for creating a composite image from a multi-frame raw image data, in accordance with one or more embodiments of the present disclosure. Method 300 commences at initiator block 301 and proceeds to block 302 at which point a raw image data that includes a plurality of frames is received. At block 304, DPS 100 extracts and determines a sharpness score of each frame of the raw image data. DPS 100 then selects a sharpest frame of the extracted frames as a reference frame (block 306). In response to selecting a reference frame, the method continues to block 308 where a next non-reference frame of the plurality of non-reference frames is selected. At block 310, one or more pixels in the selected non-reference frame are registered to pixels in the reference frame. The registered pixels and the corresponding pixels in the reference frame are then summed (block 312). At block 314, the method determines whether other non-reference frames exist that have not yet been summed. In response to determining that there are other non-reference frames that have not yet been summed, the method proceeds to block 308. In response to determining all non-reference frames have been summed, DPS 100 creates the composite image from the registered pixels (block 316). Optionally, DPS 100 may then apply one or more post processing effects to the composite image (block 318). The composite image is then provided to a local and/or remote storage and/or transmitted to a remotely connected device (block 320). The method then terminates at block 330.

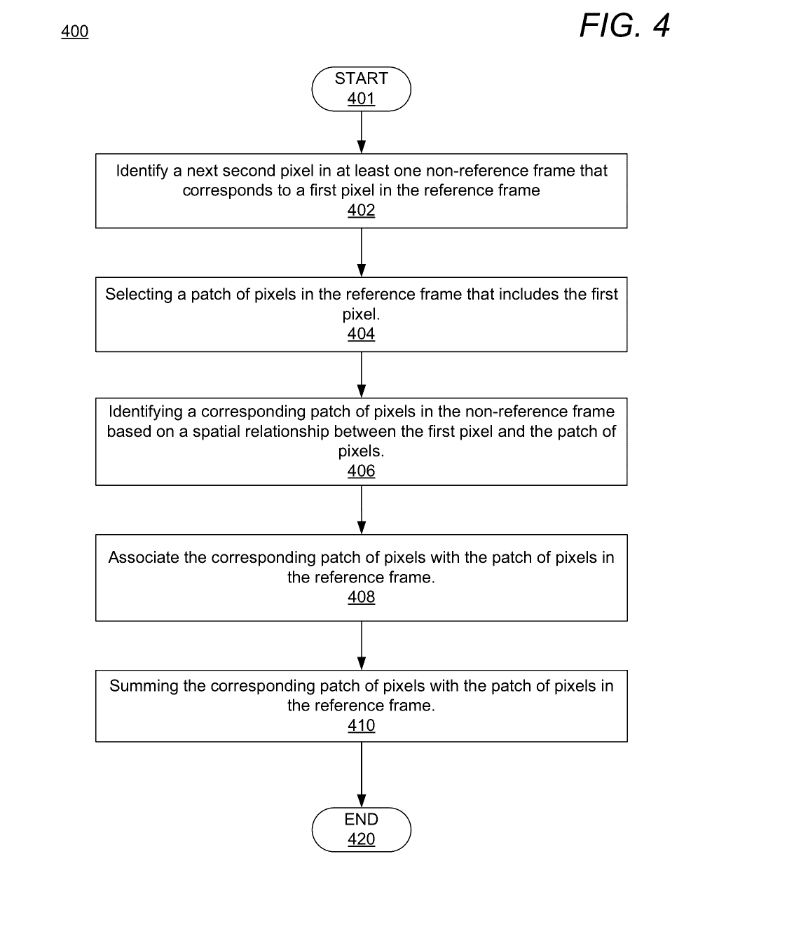

Referring now to FIG. 4, there is depicted a high-level flow-chart illustrating a method for creating a composite image from one or more identified patches in a multi-frame raw image data, in accordance with one or more embodiments of the present disclosure. Method 400 commences at initiator block 401. At block 402 DPS 100 selects a next non-reference frame of one or more non-reference frames and identifies a second pixel in the next non-reference frame that corresponds to a first pixel in the reference frame. At block 404 DPS 100 selects a patch of pixels in the reference frame that includes the first pixel. DPS 100 then identifies a corresponding patch of pixels in the selected non-reference frame, based on a spatial relationship between the first pixel and the patch of pixels (block 406). DPS 100 then associates the corresponding patching of pixels in the non-reference frame (block 408). At block 410 DPS 100 sums the corresponding patch of pixels with the patch of pixels in the reference frame. The method then terminates at block 420.

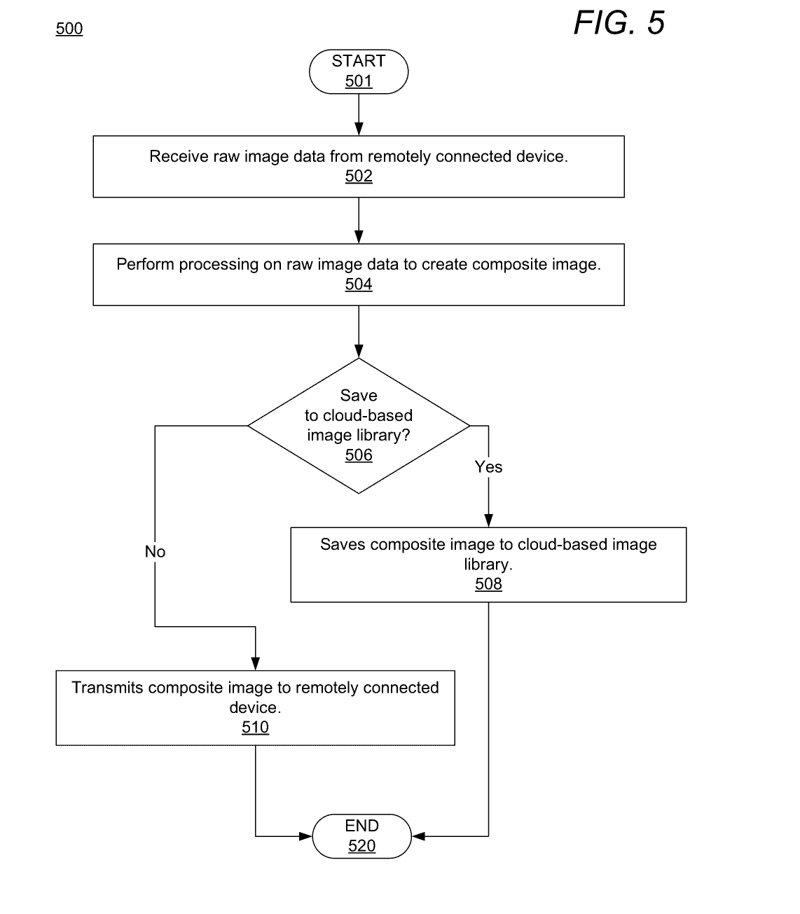

Referring now to FIG. 5, there is depicted a high-level flow-chart illustrating a method for creating a composite image from multi-frame raw image data captured by a remotely connected device, in accordance with one or more embodiments of the present disclosure. Method 500 commences at initiator block 501. At block 502 DPS 100 receives a raw image data from a remotely connected device. In another embodiment, DPS 100 may also receive motion data associated with the raw image data. At block 504 DPS 100 performs a processing on the raw image data as described in FIGS. 2-4 to create a composite image. At block 506 DPS 100 determines whether the created composite image should be saved to a cloud-based image library that is associated with the remotely connected device and/or a party using the remotely connected device. DPS 100 may determine to save the created composite image to a cloud-based image library based on: pre-established criteria; preferences associated with the remotely connected device or a party associated therewith; whether the remotely connected device is currently connected to DPS 100; or whether the remotely connected device or a party associated therewith is associated with a cloud-based image library, etc. In response to determining the composite image should be saved to a cloud-based image library, DPS 100 saves the composite image to the cloud-based image library that is associated with the remotely connected device and/or a party using the remotely connected device (block 508), and the method then terminates (block 520). In response to determining the composite image should not be saved to a cloud-based image library, DPS 100 transmits the composite image to the remotely connected device (block 510). The method then terminates at block 520.

In the above described flow charts, one or more of the method processes may be embodied in a computer readable device containing computer readable code such that a series of steps are performed when the computer readable code is executed on a computing device. In some implementations, certain steps of the methods are combined, performed simultaneously or in a different order, or perhaps omitted, without deviating from the scope of the disclosure. Thus, while the method steps are described and illustrated in a particular sequence, use of a specific sequence of steps is not meant to imply any limitations on the disclosure. Changes may be made with regards to the sequence of steps without departing from the spirit or scope of the present disclosure. Use of a particular sequence is therefore, not to be taken in a limiting sense, and the scope of the present disclosure is defined only by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object oriented programming language, without limitation. These computer program instructions may be provided to a processor of a general purpose computer, special purpose computer, or other programmable data processing apparatus to produce a machine, such that the instructions, which execute via the processor of the computer or other programmable data processing apparatus, performs the method for implementing the functions/acts specified in the flowchart and/or block diagram block or blocks.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage device may be any tangible medium that can contain, or store a program for use by or in connection with an instruction execution system, apparatus, or device.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to explain best the principles of the disclosure and the practical application, and to enable others of ordinary skill in the art to understand the disclosure for various embodiments with various modifications as are suited to the particular use contemplated.

What is claimed is:

1. A method comprising:
extracting each individual frame from a plurality of frames within raw image data;
determining a sharpness score for a region of each individual frame;
the image generating component selecting, as a reference frame, a particular frame that has a sharpest region from among the plurality of frames;
registering, to each pixel in the reference frame, a plurality of corresponding pixels from non-reference frames of the plurality of frames; and
creating a composite image by summing a plurality of registered pixels for each pixel in the reference frame.

2. The method of claim 1, further comprising:
identifying a second pixel in at least one non-reference frame that corresponds to a first pixel in the reference frame; and
associating at least one corresponding patch of pixels in at least one non-reference frame that includes the second pixel to a patch of pixels in the reference frame that includes the first pixel based on a spatial relationship between the first pixel in the reference frame relative to the remaining pixels in the patch of pixels in the reference frame;
wherein summing the plurality of registered pixels further comprises summing a plurality of associated patches of pixels in non-reference frames for each patch of pixels in the reference frame.

3. The method of claim 1, further comprising:
weighting each of the plurality of corresponding pixels based on pre-established desirability criteria;
wherein the plurality of registered pixels is a subset of the plurality of corresponding pixels that meets a threshold associated with the pre-established desirability criteria.

4. The method of claim 1, further comprising:
capturing the raw image data using at least one image sensor;
capturing motion data for each frame of the plurality of frames during capture of the raw image data, wherein the motion data describes a motion of the at least one image sensor; and
mapping, using the motion data, a motion of each individual pixel between the reference frame and the non-reference frames, wherein the mapping is utilized in the registering of the plurality of corresponding pixels;
wherein the raw image data are one of a video recording and a set of images; and
wherein the motion data are captured using at least one motion sensor.

5. The method of claim 1, further comprising:
applying at least one post-processing image enhancement from among sharpness adjustment, white balance correction, exposure compensation, and noise reduction to at least one of the reference frame, the non-reference frames, and the composite image.

6. The method of claim 1, further comprising:
performing post-processing image enhancement to at least one of: (i) a pre-summing operation to identify optimal pixels to sum; (ii) a summing operation that sums only the original non-processed frames in the composite image; and (iii) a combination of the pre-summing operation and the summing operation;

7. The method of claim 1, wherein the raw image data are received at a cloud-processing system from a remotely connected device having at least one image sensor that captured the raw image data, and the method further comprises:
retrieving motion data for each frame of the plurality of frames, wherein the raw image data are one of a video recording and a set of images, wherein the motion data are associated with motion of the at least one image sensor, and wherein the motion data was captured using at least one motion sensor;
mapping, using the motion data, a motion of each individual pixel between the reference frame and the non-reference frames, wherein the mapping is utilized in the registering of the plurality of corresponding pixels; and
in response to creating the composite image, performing at least one of: transmitting the composite image to the remotely connected device and saving the composite image to a cloud-based image library that is accessible by the remotely connected device.

8. The method of claim 1, wherein the plurality of frames are captured using at least one primary image sensor, and the method further comprises:
determining a capture location of the raw image data based on a location associated with the raw image data;
in response to determining the capture location, selecting one or more secondary frames that depict the capture location, wherein the one or more secondary frames are recorded by at least one secondary image sensor; and
summing equivalent pixels between the reference frame, each non-reference frame, and the one or more secondary frames, wherein the composite image is created using one or more pixels from the one or more secondary frames.

9. A system comprising:
an image analysis component that: extracts each individual frame from a plurality of frames within raw image data; determines a sharpness score for a region of each individual frame; and selects, as a reference frame, a particular frame that has a sharpest region from among the plurality of frames; and
an image generating component that: registers, to each pixel in the reference frame, a plurality of corresponding pixels from non-reference frames of the plurality of frames; and creates a composite image by summing a plurality of registered pixels for each pixel in the reference frame, wherein the image generating component comprises a processor executing an image processing utility.

10. The system of claim 9, wherein:
the image analysis component: identifies a second pixel in at least one non-reference frame that corresponds to a first pixel in the reference frame; and associates at least one corresponding patch of pixels in at least one non-reference frame that includes the second pixel to a patch of pixels in the reference frame that includes the first pixel based on a spatial relationship between the first pixel in the reference frame relative to the remaining pixels in the patch of pixels in the reference frame; and
the image generating component: sums a plurality of associated patches of pixels in non-reference frames for each patch of pixels in the reference frame to create the composite image.

11. The system of claim 9, wherein the image generating component weights each of the plurality of corresponding pixels based on pre-established desirability criteria, wherein the plurality of registered pixels is a subset of the plurality of corresponding pixels that meets a threshold associated with the pre-established desirability criteria.

12. The system of claim 9, further comprising:
at least one image sensor that captures the raw image data, wherein the raw image data are one of a video recording and a set of images; and
a motion detection component that captures motion data for each frame of the plurality of frames during capture of the raw image data, wherein the motion data describes a motion of the at least one image sensor, wherein the motion detection component comprises at least one motion sensor;
wherein the image generating component maps, using the motion data, a motion of each individual pixel between the reference frame and the non-reference frames, wherein the mapping is utilized in the registering of the plurality of corresponding pixels.

13. The system of claim 9, wherein the image generating component further applies at least one post-processing image enhancement from among sharpness adjustment, white balance correction, exposure compensation, and noise reduction to at least one of the reference frame, the non-reference frames, and the composite image.

14. The system of claim 9, wherein the image generating component further performs post-processing image enhancement to at least one of: (i) a pre-summing operation to identify optimal pixels to sum; (ii) a summing operation that sums only the original non-processed frames in the composite image; and (iii) a combination of the pre-summing operation and the summing operation;

15. The system of claim 9, wherein the system is a cloud processing server, wherein the system further comprises a network communication device that receives the raw image data from at least one remotely connected device having at least one image sensor that captured the raw image data, and wherein:
the image analysis component retrieves motion data for each frame of the plurality of frames, wherein the raw image data are one of a video recording and a set of images, wherein the motion data are associated with motion of the at least one image sensor, and wherein the motion data was captured using at least one motion sensor; and
the image generating component:
maps, using the motion data, a motion of each individual pixel between the reference frame and the non-reference frames, wherein the mapping is utilized in the registering of the plurality of corresponding pixels; and
in response to creating the composite image: transmits the composite image to the remotely connected device; and saves the composite image to a cloud-based image library that is accessible by the remotely connected device.

16. The system of claim 9, wherein the plurality of frames are captured using at least one primary image sensor, and wherein the image generating component further:
determines a capture location of the raw image data based on a location associated with the raw image data;
in response to determining the capture location, selects one or more secondary frames that depict the capture location, wherein the one or more secondary frames are recorded by at least one secondary image sensor; and
sums equivalent pixels between the reference frame, each non-reference frame, and the one or more secondary frames, wherein the composite image is created using one or more pixels from the one or more secondary frames.

17. A computer program product comprising:
a computer readable storage device; and
program code on the computer readable storage device that when executed within a processor provides the functionality of:
extracting each individual frame from a plurality of frames within raw image data;
determining a sharpness score for a region of each individual frame;
the image generating component selecting, as a reference frame, a particular frame that has a sharpest region from among the plurality of frames;
registering, to each pixel in the reference frame, a plurality of corresponding pixels from non-reference frames of the plurality of frames; and
creating a composite image by summing a plurality of registered pixels for each pixel in the reference frame.

18. The computer program product of claim 17, further comprising program code on the computer readable storage device that when executed within the processor provides the functionality of:
identifying a second pixel in at least one non-reference frame that corresponds to a first pixel in the reference frame; and
associating at least one corresponding patch of pixels in at least one non-reference frame that includes the second pixel to a patch of pixels in the reference frame that includes the first pixel based on a spatial relationship between the first pixel in the reference frame relative to the remaining pixels in the patch of pixels in the reference frame;
wherein summing the plurality of registered pixels further comprises summing a plurality of associated patches of pixels in non-reference frames for each patch of pixels in the reference frame.

19. The computer program product of claim 17, further comprising program code on the computer readable storage device that when executed within the processor provides the functionality of:
retrieving motion data for each frame of the plurality of frames, wherein the raw image data are one of a video recording and a set of images, wherein the motion data are associated with motion of the at least one image sensor, and wherein the motion data was captured using at least one motion sensor;
mapping, using the motion data, a motion of each individual pixel between the reference frame and the non-reference frames, wherein the mapping is utilized in the registering of the plurality of corresponding pixels; and
in response to creating the composite image, performing at least one of: transmitting the composite image to the remotely connected device and saving the composite image to a cloud-based image library that is accessible by the remotely connected device.

20. The computer program product of claim 17, further comprising program code on the computer readable storage device that when executed within the processor provides the functionality of:
determining a capture location of the raw image data based on a location associated with the raw image data;
in response to determining the capture location, selecting one or more secondary frames that depict the capture location, wherein the one or more secondary frames are recorded by at least one secondary image sensor; and
summing equivalent pixels between the reference frame, each non-reference frame, and the one or more secondary frames, wherein the composite image is created using one or more pixels from the one or more secondary frames.
